(19) United States
(12) Patent Application Publication
(10) Pub. No.: US 2016/0012245 A1
(43) Pub. Date: Jan. 14, 2016

(54) COMPUTER SECURITY RESPONSIVE TO AN OPERATING ENVIRONMENT

(71) Applicant: International Business Machines Corporation, Armonk, NY (US)

(72) Inventors: Gary D. Cudak, Creedmoor, NC (US); Christopher J. Hardee, Raleigh, NC (US); Adam Roberts, Moncure, NC (US)

(21) Appl. No.: 14/326,830

(22) Filed: Jul. 9, 2014

Related U.S. Application Data
(63) Continuation of application No. 14/326,081, filed on Jul. 8, 2014.

(51) Int. Cl. G06F 21/62; G06F 21/55

(52) U.S. Cl. CPC G06F 21/6218; G06F 21/552

(57) ABSTRACT

A method includes a compute node sensing the operating environment around the compute node during setup of the compute node and storing the operating environment sensed during setup as the predetermined operating environment. The method further includes the compute node tracking data stored by the compute node while the compute node is located within the predetermined operating environment, sensing a current operating environment of the computer system at a point in time after setup and after data has been stored by the compute node, and determining whether the current operating environment is the same as the predetermined operating environment. The compute node may then wipe the data stored by the compute node while the compute node was located within the predetermined operating environment in response to determining that the current operating environment is not the same as the predetermined operating environment.

### CROSS-REFERENCE TO RELATED APPLICATIONS

This application is a continuation of U.S. patent application Ser. No. 14/326,081 filed on Jul. 8, 2014, which application is incorporated by reference herein.

### BACKGROUND

1. Field of the Invention

The present invention relates to preventing unauthorized access to information stored in a computer.

2. Background of the Related Art

Computer systems are useful in a wide range of applications and environments. Depending upon the intended use of a particular computer system, the computer system may be designed to provide greater performance, capacity or capabilities. For example, a computer system that will perform large and complex computations may require a high speed processor or perhaps multiple high speed processors or processor cores. Furthermore, a computer system may further benefit from a greater amount of RAM memory or cache memory in order to facilitate the high speed processors. Still further, the computer system may need additional capabilities, such as a network adapter, advanced graphics processing, and the like.

It has typically been the case that even a well-designed computer system will eventually become outdated as the result of the development of new hardware with higher performance, the expanding requirements of operating system updates, the greater memory requirements of current software applications, and the amount of wear on the various components of the computer system. However, even when a computer system is no longer able to serve one purpose, the same computer system may still be more than sufficient to server another purpose. The reuse or repurposing of computer systems may provide numerous benefits. Unfortunately, the reuse or repurposing of a computer system can require significant effort or care to remove confidential or license-restricted information or configurations that should not be accessible to a new user. This effort may include wiping all information from the data storages devices and loading software needed for the new use of the computer system.

### BRIEF SUMMARY

One embodiment of the present invention provides a method, comprising a compute node sensing the operating environment around the compute node during setup of the compute node and storing the operating environment sensed during setup as the predetermined operating environment. The method further comprises the compute node tracking data stored by the compute node while the compute node is located within the predetermined operating environment, sensing a current operating environment of the computer system at a point in time after setup and after data has been stored by the compute node, and determining whether the current operating environment is the same as the predetermined operating environment. The compute node may then wipe the data stored by the compute node while the compute node was located within the predetermined operating environment in response to determining that the current operating environment is not the same as the predetermined operating environment.

### BRIEF DESCRIPTION OF THE SEVERAL VIEWS OF THE DRAWINGS

FIG. 1 is a diagram of a compute node in a hypothetical operating environment.

FIG. 2 is a flowchart of a method according to one embodiment of the present invention.

### DETAILED DESCRIPTION

One embodiment of the present invention provides a method, comprising a compute node sensing the operating environment around the compute node during setup of the compute node and storing the operating environment sensed during setup as the predetermined operating environment. The method further comprises the compute node tracking data stored by the compute node while the compute node is located within the predetermined operating environment, sensing a current operating environment of the computer system at a point in time after setup and after data has been stored by the compute node, and determining whether the current operating environment is the same as the predetermined operating environment. The compute node may then wipe the data stored by the compute node while the compute node was located within the predetermined operating environment in response to determining that the current operating environment is not the same as the predetermined operating environment.

In accordance with various embodiments of the present invention, the compute node may use various sensors and communication channels to sense components and conditions in the environment around the compute node and store that information as the predetermined operating environment in which the compute node is intended to operate. This predetermined operating environment may provide a set of parameters against which the compute node can determine whether the compute node has been moved to a new operating environment.

In another embodiment, the step of the compute node sensing a current operating environment of the computer system may include obtaining information about other compute nodes in the operating environment. For example, the compute node may communicate with other compute nodes over a network connection and obtain a media access control address or a host name associated with each of the other compute nodes. Accordingly, the step of the compute node determining whether the current operating environment is the same as a predetermined operating environment stored by the compute node may include determining whether the compute node can still access the other compute nodes. In another example, the step of the compute node sensing a current operating environment of the computer system, may include interrogating other compute nodes in the operating environment using an intelligent platform management interface (IPMI) command.

Still further, the step of the compute node sensing a current operating environment of the compute node may include sensing one or more parameter of the operating environment selected from an ambient temperature, an acoustic signal and an image. While the compute node may directly sense one or more of these parameters, the step of the compute node sensing a current operating environment of the compute node may include comparing a current correlation of system load and fan speed to a previous correlation of system load and fan speed. Since the correlation reflects the ambient temperature around the compute node, such a correlation may serve as a substitute for directly sensing the ambient temperature.

In a further alternative, the step of the compute node sensing a current operating environment of the compute node may include obtaining a global positioning system signal representing a location of the compute node. Accordingly, the compute node may determine whether the compute node is in a location other than a location associated with the predetermined operating environment. A similar approach includes discovery of wireless networks or wireless devices that indicate the compute node has been removed from a location associated with the predetermined operating environment.

The step of the compute node sensing a current operating environment of the compute node may include obtaining biometric data of a person near the compute node. While the identity of one or more person near the compute node may not be definitive as an indication that the compute node has been removed or has not been removed, if the identity of a person is entirely unknown to the compute node, or the computer system containing the compute, it may be inferred there has been a breach of security or a change in location.

In yet another embodiment, the step of the compute node determining whether the current operating environment is the same as the predetermined operating environment stored by the compute node may be performed each time the compute node is booted or performed periodically at a predetermined interval. Separately, the step of the compute node determining whether the current operating environment is the same as the predetermined operating environment stored by the compute node may include determining whether the compute node is assigned the same IP address by a Dynamic Host Configuration Protocol (DHCP) server as the compute node was previously assigned. This approach is only possible if the DHCP server is set up to assign IP addresses in this manner. It should also be appreciated that any of the steps disclosed herein for determining the current operating environment of the compute node, may also be used for determined the predetermined operating environment of the compute node.

In embodiments where the compute node includes a basis input output system (BIOS), the method may further comprise locking the basic input output system in response to determining that the current operating environment is not the same as the predetermined operating environment. Locking the BIOS prevents an unauthorized user from changing the settings or BIOS version in an attempt to bypass the security measures implemented by the BIOS.

The step of the compute node wiping data stored in the compute node may optionally include reading a stored instruction identifying the data to be wiped. In one option, the stored instruction is accessible to a basic input output system of the compute node, and the basic input output system initiates the step of the compute node wiping data stored in the compute node. In another option, the stored instruction is accessible to a unified extensible firmware interface of the compute node, and the unified extensible firmware interface initiates the step of the compute node wiping data stored in the compute node. In a preferred embodiment, the stored instruction identified data that has been stored while the compute node has been located in the predetermined operating environment.

In various embodiments, the step of the compute node wiping data stored in the compute node may include one or more action such as causing the compute node to revert to factory default settings, deleting an encryption key necessary to read encrypted data stored on a data storage device accessible to the compute node, or destroying a data storage device that stores the data. For example, the data storage device may be destroyed by releasing a chemical onto the storage medium or initiating physical damage to the storage medium.

Another embodiment of the present invention provides a computer program product comprising a computer readable storage medium having program instructions embodied therewith, the program instructions executable by a processor to cause the processor to perform a method. The method comprises a compute node sensing the operating environment around the compute node during setup of the compute node and storing the operating environment sensed during setup as the predetermined operating environment. The method further comprises the compute node tracking data stored by the compute node while the compute node is located within the predetermined operating environment, sensing a current operating environment of the computer system at a point in time after setup and after data has been stored by the compute node, and determining whether the current operating environment is the same as the predetermined operating environment. The compute node may then wipe the data stored by the compute node while the compute node was located within the predetermined operating environment in response to determining that the current operating environment is not the same as the predetermined operating environment.

The foregoing computer program product may further include program instructions for implementing or initiating any one or more aspects of the methods described herein. Accordingly, a separate description of the methods will not be duplicated in the context of a computer program product.

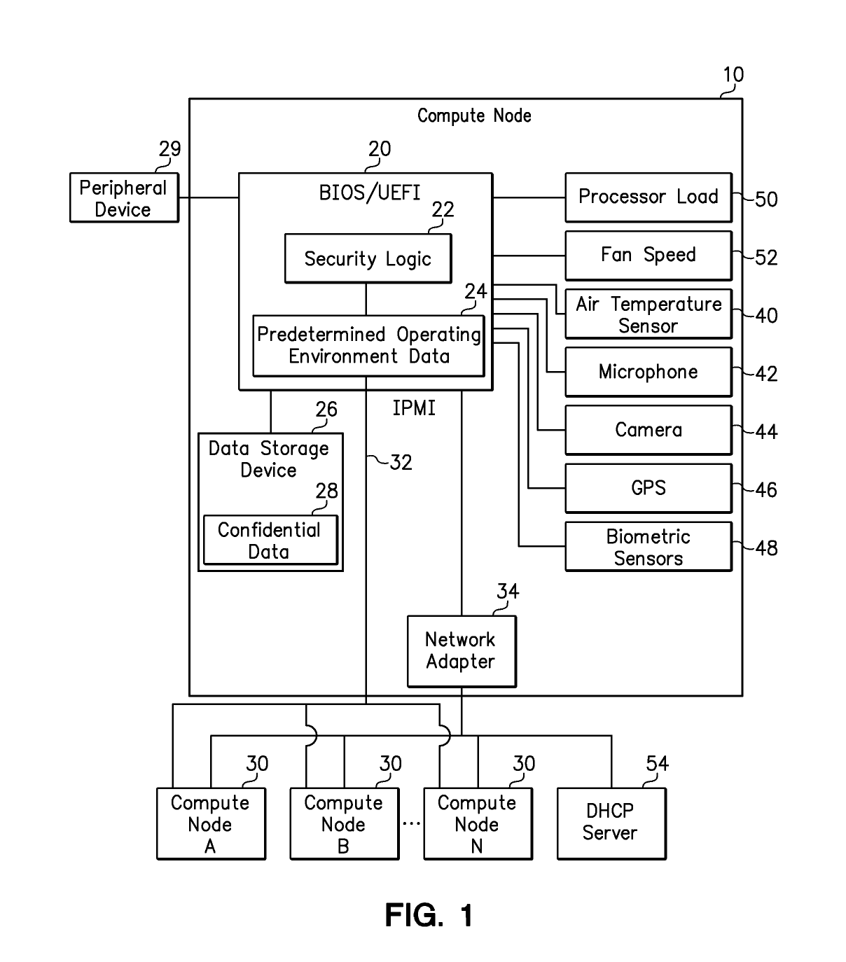

FIG. 1 is a diagram of a compute node 10 in a hypothetical operating environment. Many components of a typical compute node are not shown in order to focus on aspects of the present invention. The compute node 10 includes a basic input output system (BIOS) or a unified extensible firmware interface (UEFI) 20 that implements security logic 22 according to various embodiments of the present invention. During setup of the compute node 10, the security logic 22 may cause the BIOS 20 to sense the operating environment around the compute node and store the information collected as predetermined operating environment data 24. During subsequent booting of the compute node, or at periodic intervals or in response to other events, the BIOS 20 may again sense the current operating environment around the compute node and compare the current operating environment to the predetermined operating environment data 24. If the security logic 22 determines that the current operating environment is not the same as previously stored as the predetermined operating environment data 24, then the BIOS 20 may wipe only that confidential data 28 that is identified as having been stored in the data storage device 26 of the compute node 10 while the compute node was located in the predetermined operating environment or location.

In order to establish the predetermined operating environment data 24 and/or determine a current operating environment, the BIOS 20 may sense one or more parameters of the operating environment around the compute node 10. Such parameters may include, without limitation, identification of one or more accessible peripheral device 29, identification of one or more other compute nodes 30 either by an out-of-band IMPI command over a management bus 32 or a network communication via a network adapter 34, an air temperature measured by an air temperature sensor 40, an acoustic measurement from a microphone 42, an image from a camera 44, a location obtained from a global positioning system (GPS) module 46, and a person's identity associated with input from biometrics sensors 48. Optionally, a fan speed 52 may be correlated to a processor load 50 as a general indication of the ambient air temperature. In another option, the operating environment may be further identified by the IP address dynamically assigned to the compute node 10 by a DHCP Server 54. These and other inputs may be used to establish the predetermined operating environment data 24, perhaps during setup of the compute node 10, and to determine whether the current operating environment of the compute node 10 has changed, perhaps periodically or during each boot.

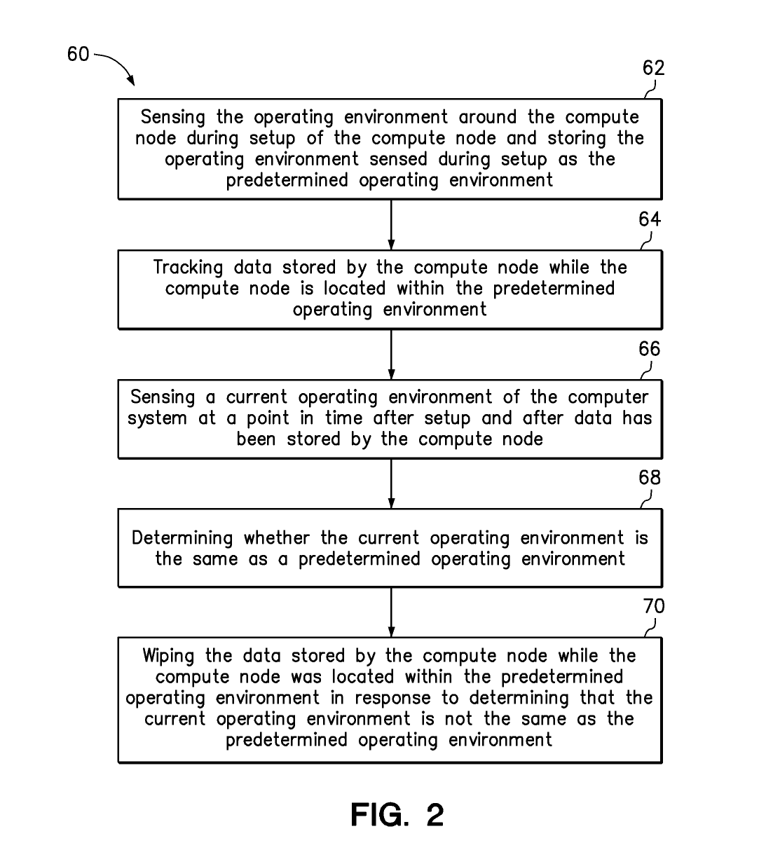

FIG. 2 is a flowchart of a method 60 performed by a compute node according to one embodiment of the present invention. In step 62, the compute node senses the operating environment around the compute node during setup of the compute node and stores the operating environment sensed during setup as the predetermined operating environment. In step 64, the compute node tracks data stored by the compute node while the compute node is located within the predetermined operating environment. Then, in step 66 of the method, the compute node senses a current operating environment of the computer system at a point in time after setup and after data has been stored by the compute node. In step 68, the compute node determines whether the current operating environment is the same as a predetermined operating environment. In step 70, the compute node wipes the data stored by the compute node while the compute node was located within the predetermined operating environment in response to determining that the current operating environment is not the same as the predetermined operating environment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a compute node sensing the operating environment around the compute node during setup of the compute node and storing the operating environment sensed during setup as the predetermined operating environment;
the compute node tracking data stored by the compute node while the compute node is located within the predetermined operating environment;
the compute node sensing a current operating environment of the computer system at a point in time after setup and after data has been stored by the compute node;
the compute node determining whether the current operating environment is the same as a predetermined operating environment; and
the compute node wiping the data stored by the compute node while the compute node was located within the predetermined operating environment in response to determining that the current operating environment is not the same as the predetermined operating environment.

2. The method of claim 1, wherein the step of the compute node sensing a current operating environment of the computer system, includes obtaining information about other compute nodes that are accessible in the operating environment.

3. The method of claim 2, wherein the information is selected from a media access control address and a host name.

4. The method of claim 3, wherein the step of the compute node determining whether the current operating environment is the same as the predetermined operating environment includes determining whether the compute node can still access the other compute nodes.

5. The method of claim 1, wherein the step of the compute node sensing a current operating environment of the computer system, includes interrogating other compute nodes in the operating environment using an intelligent platform management interface command.

6. The method of claim 1, wherein the step of the compute node sensing a current operating environment of the compute node, includes sensing one or more parameter of the operating environment selected from an ambient temperature, an acoustic signal and an image.

7. The method of claim 1, wherein the step of the compute node sensing a current operating environment of the compute node, includes comparing a current correlation of system load and fan speed to a previous correlation of system load and fan speed.

8. The method of claim 1, wherein the step of the compute node sensing a current operating environment of the compute node, includes obtaining a global positioning system signal representing a location of the compute node.

9. The method of claim 1, wherein the step of the compute node sensing a current operating environment of the compute node, includes obtaining biometric data of a person near the compute node.

10. The method of claim 1, wherein the step of the compute node determining whether the current operating environment is the same as the predetermined operating environment includes determining whether the compute node is assigned the same IP address by a Dynamic Host Configuration Protocol server as the compute node was previously assigned while located in the predetermined operating environment.

11. The method of claim 1, wherein the step of the compute node determining whether the current operating environment is the same as the predetermined operating environment is performed each time the compute node is booted.

12. The method of claim 1, wherein the step of the compute node determining whether the current operating environment is the same as the predetermined operating environment stored by the compute node is performed periodically at a predetermined interval.

13. The method of claim 1, wherein the step of the compute node wiping data stored in the compute node includes:
reading a stored instruction identifying the data to be wiped.

14. The method of claim 13, wherein the stored instruction is accessible to a basic input output system of the compute node, and the basic input output system initiates the step of the compute node wiping data stored in the compute node.

15. The method of claim 13, wherein the stored instruction is accessible to a unified extensible firmware interface of the compute node, and the unified extensible firmware interface initiates the step of the compute node wiping data stored in the compute node.

16. The method of claim 1, wherein the compute node includes a basis input output system, the method further comprising:
locking the basic input output system in response to determining that the sensed operating environment is not the same as the predetermined operating environment.

17. The method of claim 1, wherein the step of the compute node wiping data stored in the compute node includes:
causing the compute node to revert to factory default settings.

18. The method of claim 1, wherein the step of the compute node wiping data stored in the compute node includes:
deleting an encryption key necessary to read encrypted data stored on a data storage device accessible to the compute node.

19. The method of claim 1, wherein the step of the compute node wiping data stored in the compute node includes:
destroying a data storage device that stores the data.
